(19) United States
(12) Patent Application Publication
(10) Pub. No.: US 2009/0078899 A1
(43) Pub. Date: Mar. 26, 2009

(54) Solenoid Operated Vacuum Control Valve for Document Feeding

(75) Inventors: Stanley Tissue, Keetysville, MD (US); Robert Church, Fredricksburg, VA (US)

Correspondence Address: BARNES & THORNBURG LLP, 750-17TH STREET NW, SUITE 900, WASHINGTON, DC, 20006-4675, US

(73) Assignee: Advanced Pneumatics Inc., Fredericksburg, VA (US)

(21) Appl. No.: 11/858,759

(22) Filed: Sep. 20, 2007

(51) Int. Cl. F16K 31/02

(52) U.S. Cl. 251/129.15

(57) ABSTRACT

A control valve and an operating method thereof are described. The control valve includes a housing containing a valve body. A first solenoid operably connects to a first lateral end of the valve body and a second solenoid operably connects to a second lateral end of the valve body. A first fluid inlet in the housing receives a first fluid at a first predetermined pressure. A second pressure inlet in the housing receives a second fluid at a second predetermined pressure. The valve body moves between a first position, where the valve body is disposed adjacent to a first lateral side of the housing, and a second position, where the valve body is disposed adjacent to a second lateral side of the housing. In the first position, the second fluid is connected to an outlet, and, in the second position, the first fluid is connected to the outlet.

### CROSS-REFERENCE TO RELATED APPLICATIONS

This application is a first-filed application and, therefore, does not rely on any other application for priority.

### BACKGROUND

1. Field of the Invention

The present invention relates to solenoid-actuated pneumatic valve assemblies. More specifically, the present invention relates to solenoid-actuated valve assemblies controlled by a single on/off electrical controller. While applicable in a variety of environments, the solenoid-operated pneumatic valve described herein is intended for use with document feeding apparatuses.

2. Related Art

Solenoid valves currently are employed to control the flow of pressurized air or vacuum to and from pneumatically-operated devices including, in the case of pressurized air, linear actuators and rotary actuators, and, in the case of an applied vacuum, vacuum pick-up cups and vacuum belts, among others.

In one known example, individually-operated, independent solenoid valves apply and release a vacuum to a series of transport belts in mail handling and processing equipment. The transport belts transport documents, separate documents from a stack, and singularly feed documents to other equipment or destinations.

In document handling machines that are in current use, the individual pneumatic valve assemblies typically include a valve member supported within a valve body. The valve member moves between predetermined positions that are defined typically by the positions of the valve seats within the valve bore. Valve elements on the valve member engage the valve seats.

As would be appreciated by those skilled in the art, an actuator moves the valve member between the predetermined positions. In one known example, compressed air may be used to move the valve member within the valve body. Alternatively, the actuator may include an electromagnetic device, such as a solenoid pilot valve, to move the valve member in at least one direction. Where a solenoid pilot valve moves the valve member in one direction, it is common to include a coil spring, air pressure, or another electromagnetic actuating device to move the valve member in the opposite direction.

As would be understood by those skilled in the art, regardless of the actual mechanism employed to move the valve member, when the valve member moves, air pressure or vacuum is applied selectively in a document handling apparatus to grab or release documents being handles thereby. In other words, the application of a vacuum or of pressurized air is controlled by the movement of the valve member within the valve body.

A typical vacuum control valve often is operated via an electrical command applied to a solenoid coil from a control system. When energized, the solenoid coil moves the associated valve member, thereby opening the valve so that a vacuum may be applied. Movement of the valve member within the valve body may be completely provided by the electromagnetic force generated when the solenoid is activated. Alternatively, in the case where a solenoid controlled, pilot operated valve, force may be provided by air pressure (or vacuum pressure) applied directly to the valve member.

As should be appreciated by those skilled in the art, when the solenoid is de-energized, the solenoid no longer applies a force to the valve member. In the case of the solenoid controlled, pilot operated valve, releasing the air pressure (or the vacuum) from the valve member released the pressure applied to the valve member. In either case, once the force on the valve member has been released, a biasing member, such as a coil spring, repositions the valve member, typically to close the path permitting application of a vacuum.

As would be appreciated by those skilled in the art, there has been an increased demand for document handlers with increased machine speeds and machine throughputs. In response to this demand, machines have been introduced that are faster and more reliable. However, these faster and more reliable machines have not satisfied the demand in the marketplace.

One difficulty that has developed with respect to these types of machines lies in the short cycle time of the valves. The shorter the cycle time, the faster is the speed at which the valve must operate. The faster the speed, the greater is the chance for valve failure.

An additional difficulty that has arisen concerns the volume of air that must flow through a particular orifice in order to provide sufficient functionality to the document handler. Physics dictates that the volume of air that flows through a particular orifice in a specified time period is a function of the pressure differential across the orifice. The higher the pressure differential, the higher the flow rate will be. For this reason, among others, vacuum control valves generally require large orifices to attain high flow rates. In the case of a vacuum, however, physics dictates that there is a finite pressure differential that can be reasonably attained. Increasing the pressure differential, therefore, is not an option.

One further difficulty that has arisen in connection with the prior art concerns the utilization of large orifices. Specifically, larger orifices require that larger diameter valve elements be opened and closed during valve operation. In addition, larger orifices require that the valve members be longer and that they travel a longer distance. An increase in the size of the valve elements results in an increase in the mass of the valve elements, thereby increasing the force require to move the valve elements from the opened to the closed positions. An increase in the weight also requires that the biasing element, such as the coil spring, provide a greater return force to reposition the valve elements. As is immediately apparent, the increase in size and mass of the valve element necessitates in increase in the size and operative force that the solenoid may apply to the larger, heavier valve element. The use of larger and larger solenoid valves becomes impractical due to their size and electrical consumption requirements.

Still further, as should be appreciated by those skilled in the art, document handling machines are exposed to a large quantity of paper dust and dirt. Typically, the dust and dirt pass through the valve and frequently accumulate within the valve. Eventually, enough paper and dirt particles accumulate within the valve to impede the operation of the valve by increasing resistance of the valve member to movement. In addition, paper and dirt particles have an abrasive quality that accelerates wear on valve elements, seals, and bores.

In view of some of these difficulties, solenoid controlled air pilot valves are preferred to control the application of a vacuum on document handling machines. These valves employ a small, solenoid-operated valve that directs compressed air such that the compressed air flows to position the larger main valve element to the desired position, whether open or closed. This valve design also allows for the use of smaller, lower power-consuming solenoids, while providing higher forces from the compressed air source to position the valve elements.

With respect to valve control, as discussed above, to simplify the logic for opening and closing the valves in known devices, it is typical to employ a solenoid to open a valve and a spring coil to close the valve once the solenoid has been de-energized. These valves are known as single solenoid, spring return valves. To control the operation of these types of valves, an electrical signal is applied to the solenoid for a time period during which the valve is to be opened. When the valve is to be closed, power to the solenoid is cut off.

One drawback associated with these pilot operated, spring return valves concerns the cycle time required for these valves. In particular, the response cycle time of these types of valves is not consistent with the current demand for shorter cycle times. Coupled with an increased demand for improved reliability and an increased life expectancy for the vacuum control valve, there remains a need for a device that resolves many of the difficulties noted herein.

An additional concern, which is raised above, involves the accumulation of paper dust and dirt on the valve elements. After the valve ingests enough dust and dirt, the valve element can wear prematurely, resulting in the inability of the valve to provide a sufficient vacuum.

Premature wear of seal elements, among other areas of wear, is of particular concern with respect to document feeding apparatuses. When seals and valve elements wear prematurely, they are no longer able to isolate the vacuum or pressurized air applied to the pilot supply from the main valve flow paths, for example. One result is that, during the time when the valve is energized (or open), and vacuum is being applied via the valve element, positive pressure from the compressed air pilot supply bypasses the worn seals and enters the main vacuum supply path, resulting in a loss of vacuum at the point of application (e.g., at the point where the vacuum is applied to the document being handled). This may cause a failure of the document handling apparatus.

Accordingly, a need remains in the industry for a document handling apparatus that does not present at least some of the limitations listed above.

### SUMMARY

The document handling apparatus described by the present disclosure addresses many of the deficiencies noted above with respect to the related art.

As noted above, there is a growing trend for document handlers with valves that operate with shorter cycle times and, accordingly, shorter control response times. The inventors of the invention discussed by the present disclosure recognized that one way of reducing the control valve response time is to reduce, or eliminate altogether, the need for the biasing element in the valve. In other words, the inventors recognized that the elimination of the spring coil in the conventional valve controller could offer advantages not previously appreciated by those skilled in the art.

As recognized by the inventors, when the biasing force of the coil spring is removed, a force must still be applied to move the valve element in a reverse direction. The invention described by the present disclosure provides at least one solution to this problem by providing a dual-actuated solenoid valve arrangement using a singular electrical control scheme.

Accordingly, one aspect of the invention is to provide a control valve with a housing that defines a first lateral side and a second lateral side, a valve body disposed within the housing, wherein the valve body defines a first lateral end and a second lateral end, a first solenoid operably connected to the first lateral end of the valve body, a second solenoid operably connected to the second lateral end of the valve body, a first fluid inlet in the housing adapted to receive a first fluid, wherein the first fluid is at a first predetermined pressure, a second pressure inlet in the housing adapted to receive a second fluid, wherein the second fluid is at a second predetermined pressure, an outlet defined in the housing, wherein the valve body is moveable between a first position and a second position, wherein, in the first position, the valve body is disposed adjacent to the first lateral side of the housing, wherein, in the second position, the valve body is disposed adjacent to the second lateral side of the housing, wherein, in the first position, the second fluid is connected to the outlet, and wherein, in the second position, the first fluid is connected to the outlet.

Still another aspect of the invention is to provide a control valve where the first predetermined pressure is less than the second predetermined pressure.

One further aspect of the invention is to provide a control valve where the first fluid and the second fluid are both gases.

An additional aspect of the invention is to provide a control valve where the first fluid and the second are both air.

The invention also provides for a control valve where the second predetermined pressure is atmospheric pressure.

In addition, the invention provides for a control valve where the first predetermined pressure is a vacuum.

Next, the invention provides for a control valve where the first solenoid is disposed on the first lateral side of the housing.

Additionally, the invention provides for a control valve where the second solenoid is disposed on the second lateral side of the housing.

A further aspect of the invention is to provide a control valve where the valve body comprises a valve stem and plurality of valve members disposed at predetermined positions on the valve stem, where the housing defines a plurality of valve seats, and where the plurality of valve members engage the plurality of valve seats when the valve body is in the first and second positions.

It is also an aspect of the invention to provide a control valve where the plurality of valve members comprise at least one first valve member and at least one second valve member, where the plurality of valve seats comprise at least one first valve seat and at least one second vale seat, where the at least one first valve member engages the at least one first valve seat when the valve body is in the first position, and where the at least one second valve member engages the at least one second valve seat when the valve body is in the second position.

Another aspect of the invention is to provide a method of operating a control valve with a housing that defines a first lateral side and a second lateral side, a valve body disposed within the housing, wherein the valve body defines a first lateral end and a second lateral end, a first solenoid operably connected to the first lateral end of the valve body, a second solenoid operably connected to the second lateral end of the valve body, a first fluid inlet in the housing adapted to receive a first fluid, wherein the first fluid is at a first predetermined pressure, a second pressure inlet in the housing adapted to receive a second fluid, wherein the second fluid is at a second predetermined pressure, an outlet defined in the housing, where the method includes energizing one of the first or second solenoids, moving the valve body to the first position as a result of energizing the one of the first or second solenoids, connecting the first fluid to the outlet as a result of moving the valve body to the first position, energizing the other of the first or second solenoids, moving the valve body to the second position as a result of energizing the other of the first or second solenoids, and connecting the second fluid to the outlet as a result of moving the valve body to the second position.

In connection with the method, the invention provides that, in the first position, the valve body is disposed adjacent to the first lateral side of the housing.

Further in connection with the method, the invention provides that, in the second position, the valve body is disposed adjacent to the second lateral side of the housing.

Additionally, the invention provides for a method where the second solenoid is energized to move the valve body to the first position and the first solenoid is energized to move the valve body to the second position.

Next, the invention provides for a method where, by energizing the other of the first or second solenoids, the first fluid is disconnected from the outlet.

The invention also provides for a method where the first and second solenoids are energized cyclically to repeatedly connect and disconnect the first and second fluids to and from the outlet.

The invention provides for a method where the first and second fluids are cyclically connected to and from the outlet during a time period of less or equal to about 15 ms.

Additionally, the invention provides for a method where the time period of less than or equal to about 10 ms.

Further still, the invention provides for a method where the time period of less than or equal to about 6 ms.

Also, the invention provides for a method where the first fluid is a vacuum and the second fluid is air at substantially atmospheric pressure.

Other aspects of the invention will be apparent to those skilled in the art.

### BRIEF DESCRIPTION OF THE DRAWINGS

The drawings appended hereto illustrate various aspects of apparatuses and systems in which:

FIG. 1 is a perspective view of the solenoid valve of the present invention, illustrated in a first operational position;

FIG. 2 is a perspective view of the solenoid valve shown in FIG. 1, illustrated in a second operational position;

FIG. 3 is a schematic illustration of a valve body for the solenoid valve shown in FIGS. 1 and 2;

FIG. 4 is a schematic illustration of the solenoid valve shown in FIGS. 1 and 2, showing various of the passageways in a housing of the solenoid valve, the valve body being shown in the first operational position;

FIG. 5 is a schematic illustration of the solenoid valve shown in FIGS. 1 and 2, showing the application of a vacuum to certain passageways in the housing of the solenoid valve when the valve body is in the first operational position;

FIG. 6 is a schematic illustration of the solenoid valve shown in FIGS. 1 and 2, showing the application of a pressurized gas to certain passageways in the housing of the solenoid valve when the valve body is in the first operational position;

FIG. 7 is a schematic illustration of the solenoid valve shown in FIGS. 1 and 2 when the valve body is in the first operational position; and

FIG. 8 is a schematic illustration of the solenoid valve shown in FIGS. 1 and 2 when the valve body is in the second operational position.

### DETAILED DESCRIPTION

While various embodiments are described herein, they are merely illustrative and are not limiting. The Applicant intends for the following description to encompass embodiments and variations not described herein, as would be understood by those skilled in the art.

As a preliminary matter, since the present invention is directed to the application of a vacuum or of pressurized air for specific purposes, the description herein will refer to air flow and also to vacuum flow. As would be appreciated by those skilled in the art, the “flow” of a vacuum refers to the application of a pressure that is less than atmospheric pressure, or at least a pressure less than the pressure of the complimentary higher pressure gas that is applied. In addition, while the discussion that follows refers specifically to air, the present invention is applicable to any pressurized gas, not necessarily air. For example, a pure gas, such as nitrogen or a noble gas may be employed without departing from the scope of the present invention. Any gas may be used.

In addition, the present invention is contemplated to be used in connection with a document handler. For this reason, among others, the present invention utilizes air and a vacuum pump to create a negative relative pressure. It is contemplated that the solenoid valve of the present invention could be applied to devices other than document handlers. In such cases, it is contemplated that the present invention could also be applied in an environment involving any type of fluid, such as water, oil, or the like.

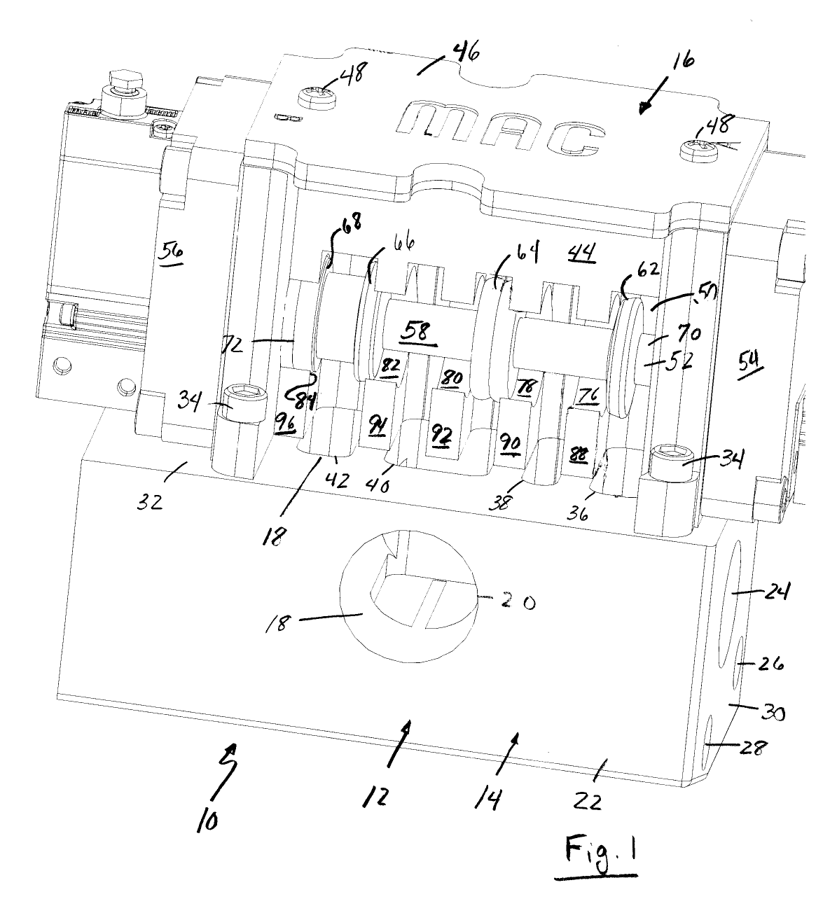

FIG. 1 is a perspective illustration of a solenoid valve 10. The solenoid valve 10 includes a housing 12. The housing 12 includes a pressure block 14 and a valve block 16. In the illustrated embodiment, the valve block 16 is positioned atop the pressure block 14. As would be appreciated by those skilled in the art, however, this orientation may be reversed without departing from the scope of the present invention.

The pressure block 14 defines passageways 18 therein to selectively apply the pressurized fluid as required by the device operatively connected to the solenoid valve 10. The specific layout of the passageways 18 is not illustrated herein. As would be appreciated by those skilled in the art, the layout of the passageways 18 should be selected as required by the device to which the solenoid valve 10 is connected. As indicated, the solenoid valve 10 is designed for use with a document handler (not illustrated). It is intended, however, that the solenoid valve 10 may be used with any other suitable apparatus requiring the intermittent application of a pressurized fluid and of a vacuum, as noted.

The pressure block 14 is so named because it defines passageways 18 that permit the application of a vacuum or of a pressurized gas to those parts of the apparatus to which the solenoid valve 10 is connected. Portions of the passageways 18 are visible in the various figures appended hereto. As illustrated in FIG. 1, for example, the passageways 18 include an opening 20 through a forward facing surface 22. The opening 20 may be connected to the apparatus to which the solenoid valve 10 is connected, such as a document handler.

To facilitate the following discussion, the solenoid valve 10 will be described in connection with a document handler. It is noted, as above, that this is but one application of the solenoid valve 10 of the present invention and should not be understood to be limited solely to this application.

The opening 20 opens into the internal passageways 18, which include further openings 24, 26, 28 in a lateral facing surface 30 of the pressure bock 14. The openings 24, 26, 28 may be connected to the source of pressurized gas, atmosphere, and vacuum, among others, as would be appreciated by those skilled in the art. In addition, while the openings 20, 24, 26, 28 are shown in the forward facing surface 22 and the lateral facing surface 30 of the pressure block 14, this is not intended to be limiting of the scope of the present invention. As would be appreciated by those skilled in the art, the pressure block 14 may include openings in any other facing surface thereof. In addition, while there are four opening 20, 24, 26, 28 illustrated, a larger or a fewer number of openings may be employed without departing from the scope of the present invention.

With respect to the pressure block 14, a rectangular shape is illustrated for purposes of describing the embodiment shown. As would be appreciated by those skilled in the art, however, the rectangular shape is merely illustrative. Any other shape may be employed without departing from the scope of the present invention. In addition, the pressure block 14 may be fashioned as a unitary structure. As also should be appreciated by those skilled in the art, however, the pressure block 14 may be fashioned from several components that are assembled together, via welding, machining, with fasteners, or the like.

The pressure block 14 includes a top facing surface 32. The top facing surface 32 abuts against a bottom surface of the valve block 16 in the illustrated embodiment. The pressure block 14 is connected to the valve block 16 via one or more fasteners 34. The fasteners 34 may be screws, as illustrated, or any other suitable fasteners without departing from the scope of the present invention. The fasteners 34 connect the valve block 16 to the pressure block 14 and apply a suitable pressure to maintain a sufficient seal between the pressure block 14 and valve block 16.

One or more seals (not illustrated), may be positioned between the pressure block 14 and the valve block 16 to help maintain a seal between the two blocks, as would be appreciated by those skilled in the art. The one or more seals may include, but are not limited to, any type of compressible seals such as rubber or polytetrafluoroethylene. The seals may be o-rings or other suitable sealing members.

The top facing surface 32 of the pressure block 14 includes four openings 36, 38, 40, 42, all of which open into the passageways within the pressure block 14. These openings 36, 38, 40, 42 will be described in greater detail below. As a preliminary note, these openings 36, 38, 40, 42 provide a communicative link between the source of pressurized gas or vacuum to and from the valve block 16.

It is contemplated that the pressure block 14 and the valve block 16 could be constructed as a unitary structure. If so, the pressurized gas and vacuum would be applied through the unitary structure, as would be appreciated by those skilled in the art.

It is also noted that the various passageways that are described in connection with the pressure block 14 and the valve block 16 are not exclusive to either block. It is contemplated that the two blocks 14, 16 that form the housing 12 will define the various passageways described herein. Accordingly, while a passageway may be attributed to one of either the pressure block 14 or the valve block 16 herein, this should not be construed as a limitation on the scope of the invention. Moreover, if the housing 12 is constructed such that there are not separate blocks 14, 16, the housing 12 is contemplated to define all of the passageways discussed herein.

The valve block 16 includes several parts that are assembled together. As illustrated in FIG. 1, the valve block 16 includes a body 44 and a top 46. The top 46 may be secured to the body 44 via one or more fasteners 48. In FIG. 1, the tops of screws 48 are illustrated. Screws are but one type of fastener contemplated to secure the top 46 to the body 44. Other fasteners may be used without departing from the scope of the invention.

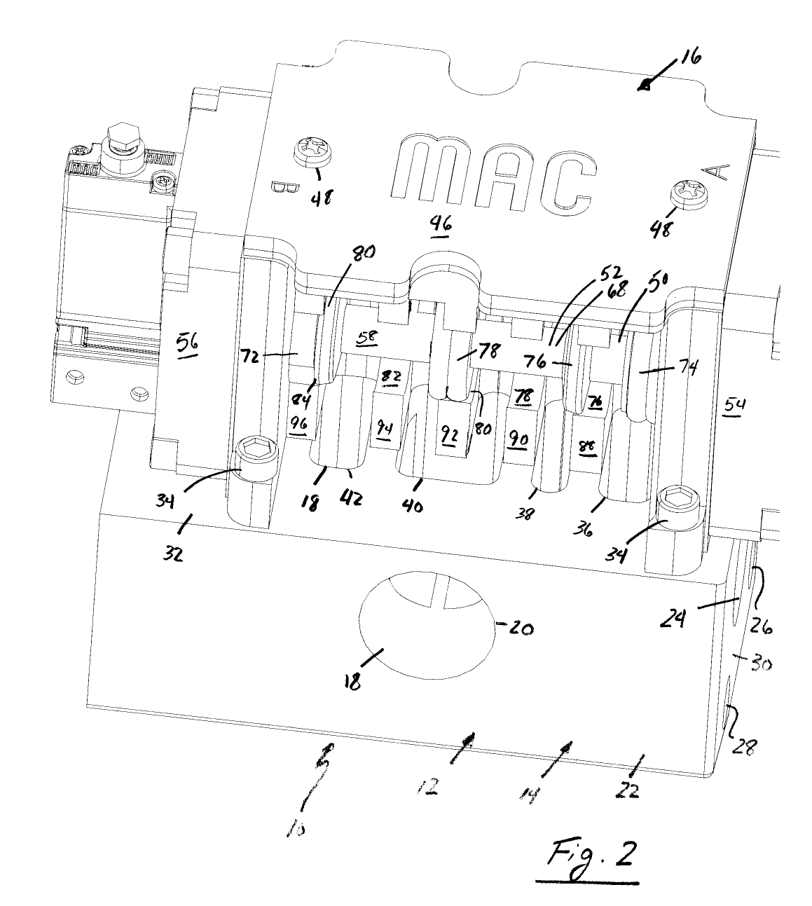

It is noted that a front wall of the body 44 of the valve block 16 has been removed from the illustrations in FIGS. 1 and 2 to assist with an understanding of the solenoid valve 10. In actual operation, a front wall would be provided, as would be appreciated by those skilled in the art.

As with the pressure block 14, the valve block 16 may be a unitary construction. The valve block 16 may be fashioned as a single unit, or it may be a composite of a number of separate elements that have been assembled together. As would be appreciated by those skilled in the art, the valve block 16 may be constructed in any number of ways without departing from the scope of the present invention.

The body 44 of the valve block 16 defines a valve bore 50. A valve body 52 is moveably disposed within the valve bore 50. The valve body 52 is pushed in the lateral directions within the valve block 16 by a first solenoid 54 and a second solenoid 56, which are disposed on the lateral ends of the valve block 16. The first solenoid 54 is disposed on a first lateral end of the valve block, labeled “A”, while the second solenoid 56 is disposed on the opposite, lateral end of the valve block 16, labeled “B”. The first and second solenoids 54, 56 are positioned such that their respective operations, as described more fully herein, oppose one another. To assist with an understanding of the present invention, the labels “A” and “B” will be used consistently throughout the drawings, where appropriate.

The valve body 52 consists of a valve stem 58 that includes a first valve member 60, a second valve member 62, a third valve member 64, a fourth valve member 66, and a fifth valve member 68 disposed thereon between the first lateral end 70 and the second lateral end 72 thereof. FIG. 1 illustrates four of the valve members 62, 64, 66, 68. In FIG. 1, the first valve member 60 is obstructed from view due to the angle of the perspective illustration.

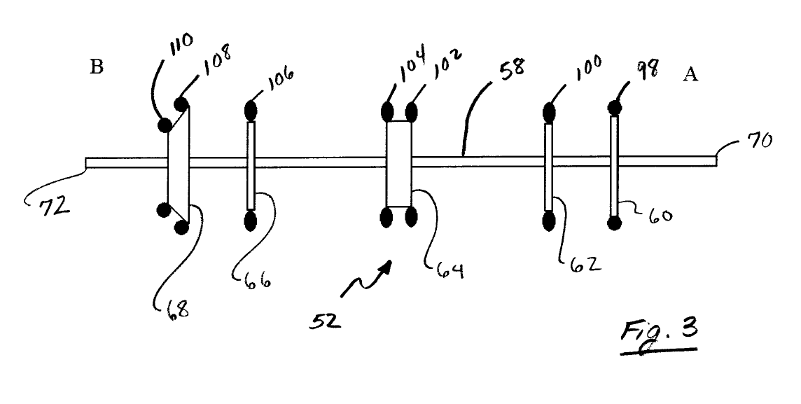

During operation, the five valve members 60, 62, 64, 66, 68 engage first, second, third, fourth, fifth, and sixth valve seats 74, 76, 78, 80, 82, 84, respectively. The six valve seats 74, 76, 78, 80, 82, 84 are defined by first, second, third, fourth, fifth, and sixth walls 86, 88, 90, 92, 94, 96. In FIG. 1, the first valve seat 74 and the first wall 86 are obstructed from view due to the angle of the perspective. These structures are best illustrated in FIG. 3. It is noted that the first valve seat 74 may be seen in FIG. 2.

As indicated in FIGS. 1 and 2, the first through sixth valve seats 74, 76, 78, 80, 82, 84 are circular holes through the respective walls 86, 88, 90, 92, 94, 96. To mate with the valve seats 74, 76, 78, 80, 82, 84 the first through fourth valve members 60, 62, 64, 66 also have circular cross-sections. As would be appreciated by those skilled in the art, however, any shape other than a circular shape may be used for the valve members 60, 62, 64, 66 and the valve seats 74, 76, 78, 80, 82, 84 without departing from the scope of the invention.

FIG. 2 illustrates the solenoid valve 10 in a second operational position. As with FIG. 1, the front wall of the valve block 16 is not shown. In this second operational position, the valve body 52 has been shifted from the end of the valve block 16 with the first solenoid 54 toward the end of the valve block 16 with the second solenoid 56. In this view, the first valve seat 74 is visible.

As a point of reference, it is noted that the position of the valve body 52 illustrated in FIG. 1 isolates the vacuum supply from the document handler. In contrast, the position of the valve body 52 illustrated in FIG. 2 permits a vacuum to be applied to the vacuum belt (or similar suitable structure) associated with the document handler. It is also noted at this point that the isolation of the vacuum from the document handler may involve the application of a gas at ambient conditions or may involve the application of a gas at higher than ambient conditions. Regardless, it is contemplated that the isolation of the vacuum from the document handler will result in the application of a gas at a pressure higher than that of the vacuum.

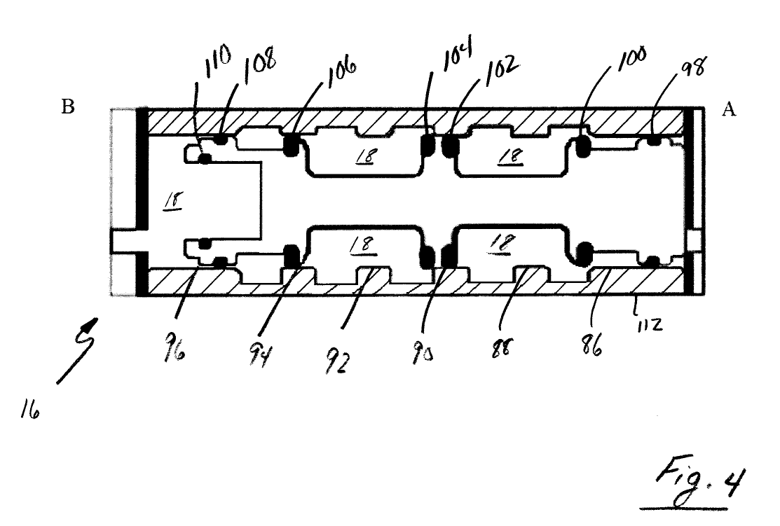

FIG. 3 is a side view of one contemplated embodiment of the valve body 52 for the solenoid valve 10. The valve body 52 is illustrated in a simplified format to facilitate discussion of FIGS. 4, 5, and 6 that follow.

In FIG. 3, the valve stem 58 is illustrated as a single, cylindrical structure along which each of the valve members 60, 62, 64, 66, 68 are disposed. In the embodiment illustrated in FIGS. 1 and 2, the valve stem 58 is a cylindrical rod that extends from its first lateral end 70 to its second lateral end 72. The first valve member 60, the second valve member 62, the third valve member 64, and the fourth valve member 66 are each illustrated as cylindrical structures that are located, at predetermined positions on the valve stem 58. The fifth valve member 68 is illustrated as a partial frusto-conical structure. As would be appreciated by those skilled in the art, the valve members 60, 62, 64, 66, 68 may take any shape as needed without departing from the scope of the present invention.

In FIG. 3, each of the valve members 60, 62, 64, 66, 68 are provided with one or more sealing elements. It is contemplated that the sealing elements are made of an elastomeric material, such as rubber. It is also contemplated that the sealing elements may be rubber o-rings, as would be appreciated by those skilled in the art. Of course, as also would be appreciated by those skilled in the art, the sealing elements may be made from an alternative, suitable material such as polytetrafluoroethylene or other compressible material. In addition, the sealing elements need not be o-rings.

As illustrated in FIG. 3, the first valve member includes a first o-ring 98 that extends around its periphery. The second valve member 62 has a second o-ring 100 encircling its periphery. The third valve member 64 includes two o-rings, a third o-ring 102 and a fourth o-ring 104. The fourth valve member 66 has a single o-ring 106 disposed thereon. The fifth valve seat 68 includes two o-rings, a sixth o-ring 108 and a seventh o-ring 110, disposed about its periphery. As should be appreciated by those skilled in the art, the o-rings 98, 100, 102, 104, 106, 108, 110 assist the valve members 60, 62, 64, 66, 68 to establish an appropriate seal with the valve seat 74, 76, 78, 80, 82 that it engages.

As noted above, to facilitate understanding of the position of the valve body 52 within the valve block 14, the labels “A” and “B” are included in FIG. 3. These labels correspond to the lateral sides of the solenoid valve 10 as indicated in FIGS. 1 and 2.

FIG. 4 provides a schematic illustration of the valve block 16 illustrated in FIGS. 1 and 2. In this illustration, the valve body 52 is positioned as in FIG. 1. In this illustration, a front wall 112 is shown, which was omitted for ease of discussion from FIGS. 1 and 2.

In the position illustrated in FIG. 4, the valve body 52 isolates the vacuum from the document handler or other device to which the solenoid valve 10 is connected. The valve body 52 has been omitted from this illustration so as not to overly complicate the drawing. Instead of showing the entirety of the valve body, the positions of the o-rings 98, 100, 102, 104, 106, 108, 110 are shown in relation to the interior of the valve block 16. The walls 86, 88, 90, 92, 94, 96 are also illustrated. The lateral ends of the valve block 16, labeled “A” and “B”, are also provided as a reference. As discussed above, the interior of the valve block 16 defines a number of passageways 18.

Before discussing the operational connections between the various passageways 18 in the valve block 16, it s noted that passageways each have complimentary components due to the illustrated construction of the vale housing 16. Accordingly, while reference is made to the passageways 18 at the lower portions of FIGS. 4, 5, and 6, the same discussion applies to the complimentary portions of the passageways 18, which are illustrated at the upper portions of the drawings in FIGS. 4, 5, and 6.

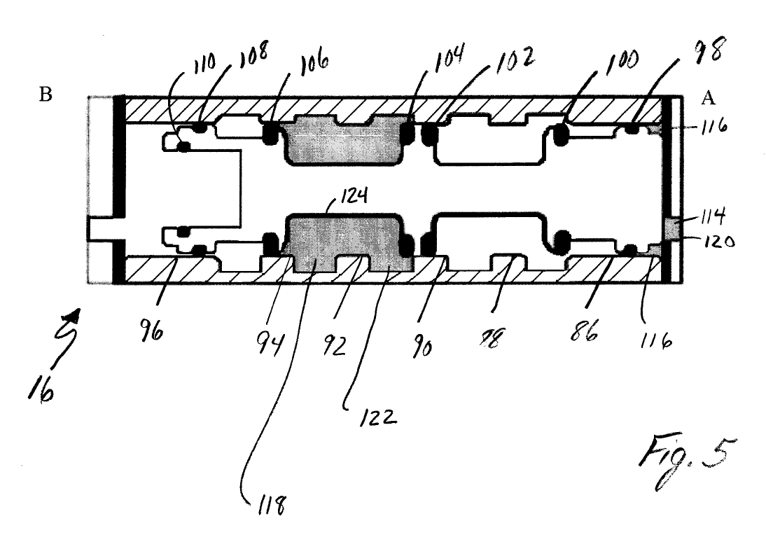

Like FIG. 4, FIG. 5 illustrates the first operational position of the solenoid valve 10. In this first operational position, the valve body 52 is disposed within the valve block such that a vacuum is applied to the passageways 18 that are highlighted in FIG. 5. Specifically, when the valve body 52 is in the first position, a vacuum flows through the passageways 114, 116, 118. The first passageway 114 defines an inlet 120 from a vacuum source. The passageway 116 connects the vacuum from the vacuum inlet 120 to the passageway 118. Vacuum flowing through the passageway 118 is isolated from the device to which the solenoid valve 10 is connected. In other words, the vacuum is not applied to the document handler when the valve body 52 is in this first position.

As shown, the passageway 118 defines an inlet connection to the vacuum source via the first solenoid 54, otherwise referred to as solenoid “A” in the drawings. It is noted that the passageway 122 defines an exhaust connection from the combined passageway 124. As a result, vacuum flows from the vacuum inlet 114, through the passageway 116, enters the inlet portion 118 from the passageway 116, and exits the valve block 16 via the exhaust portion 122. The passageway 124 connects the inlet portion 118 to the exhaust portion 122. Since the exhaust portion 122 is not connected to the document handler, the vacuum is not supplied to the vacuum handler. In other words, in this first operational state, the passageways 118, 122 are connected to the vacuum source, but are isolated from the document handler.

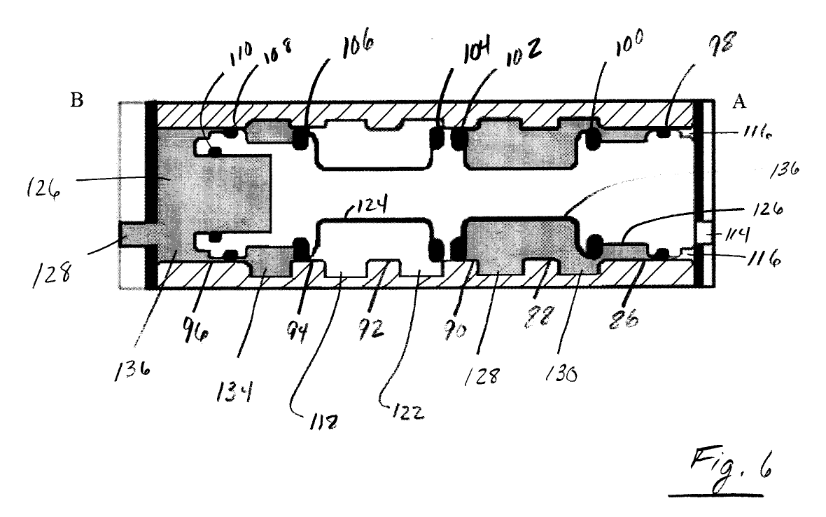

FIG. 6 provides an illustration of the remaining passageways 18 within the valve block 16. In this illustration, the passageways 126, 128, 130, 132, 134 are highlighted. As with the combined passageway 124, there is a combined passageway 136 that connects the passageway 128 to the passageway 130.

As in FIGS. 4 and 5, in FIG. 6, the valve body 52 remains in the first operational position. The passageways 126, 128, 130, 132, 134 contain a non-vacuum gas that is at a higher pressure than that of the vacuum. In particular, it is contemplated that the passageways 126, 128, 130, 132, 134 will be open to the atmosphere and will, therefore, be at atmospheric pressure.

In FIG. 6, the passageway 128 defines an inlet for the non-vacuum fluid into the valve block 16. The inlet 128 is connected to the passageway 126, which defines a chamber within the valve block. In turn, the passageway 126 connects with the passageway 134, which is also considered as an inlet. The inlet 134 is connected to the passageway 130, which also is considered to be an inlet. Via the combined passageway 136, passageways 128 and 130 are connected to one another. Passageway 128 is connected to the second solenoid 156, otherwise referred to as solenoid “B” in the drawings.

As should be apparent, the passageway 134 connects with the passageway 130. When the valve body 52 is in the first position, the passageway 130 is connected to the passageway 128 via the combined passageway 136. It is noted that the passageway 130 communicates with the atmosphere in the illustrated embodiment. Accordingly, the vacuum belt of the document handler is open to the atmosphere in this illustration, but only through the passageway 130.

The passageway 134 and the passageway 128 also function to supply a vacuum to the document handler when the valve body has been moved to the second operational position. As should be apparent to those skilled in the art, when the valve body 52 is moved to the left (with reference to FIGS. 4, 5, and 6), the passage 118 becomes connected to the passage 134 via the passage 124. Similarly, the passage 122 becomes connected to the passage 128 via the passage 136. As a result, the passageways 134 and 128 create a flow path for the application of the vacuum to the vacuum belt of the document handler. When the valve body 52 is shifted to the second position, passageway 134 is connected to passageway 118, and passageway 122 is connected to passageway 128, this state also is referred to as a “dual flow” state since vacuum is being supplied to the vacuum belt via the passageway 134 and via the passageway 128.

Although it should be apparent from the foregoing discussion, the first solenoid 54 acts on the first lateral end 70 of the valve body 52. Similarly, the second solenoid 54 acts on the second lateral end 72 of the valve body. When the first solenoid 54 is actuated, the solenoid 54 pushes the valve body 52 into the second operational position. When the second solenoid 56 is actuated, the valve body is pushed into the first operational position.

While this is the contemplated mode of operation, it is also contemplated that a reverse operation of the solenoids 54, 56 also may be employed without departing from the scope of the present invention. Specifically, in the reverse operation, the solenoids 54, 56 may pull on the valve body. In this contemplated arrangement, when the first solenoid 54 is actuated, the solenoid will pull the valve body into the first operational position. When the second solenoid 56 is operated in this embodiment, the solenoid 56 pulls the valve body 52 in to the second operational position.

The selection of whether the solenoids 54, 56 push or pull on the valve body 52 is left to those skilled in the art. It is contemplated that this operational selection will depend on the particular apparatus to which the solenoid valve 10 is connected.

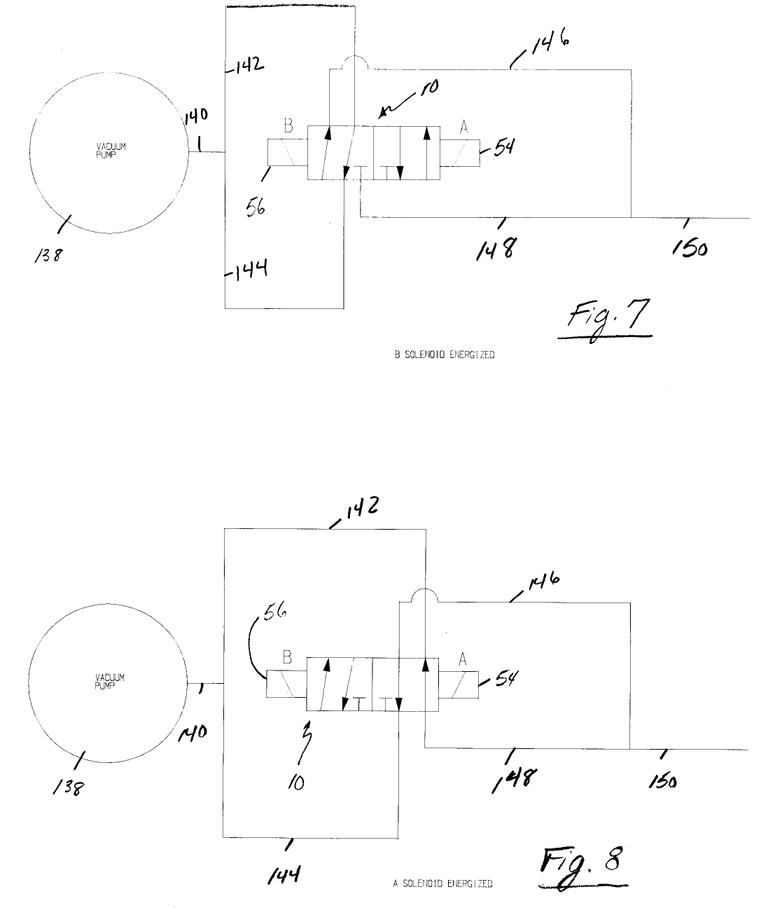

The operation of the solenoid valve 10 will now be discussed in greater detail in connection with FIGS. 7-8.

FIGS. 7 and 8 are operational schematic diagrams for the solenoid valve 10 of the present invention. FIG. 7 illustrates the first operational position of the valve body 52, where the vacuum is isolated from the vacuum belt. FIG. 8 illustrates the second operational position, where the vacuum is supplied to the vacuum belt. As noted in FIG. 7, the second solenoid 56 (solenoid “B”) is energized to place the valve body 52 into the first operational position. As noted in FIG. 8, the first solenoid (solenoid “A”) is energized to please the valve body into the second operational position.

Referring to FIG. 7, the vacuum pump 138 is connected to a passageway 140. The passageway 140 is connected to a passageway 142 that extends to the housing 12. The passageway 140 also connects to a passageway 144 that, in turn, connects to the housing 12.

As also illustrated in FIG. 7, a passageway 146 extends from the housing 12 to connect with a passageway 148 that also extends from the housing 12. The two passageways 146, 148 both connect to passageway 150. Passageway 150 connects to the vacuum belt of the document handler.

As FIG. 7 illustrates, when the valve body 52 is in the first operational position, the vacuum is isolated from the document handler. However, via the passageway 128 in the housing 12, atmosphere is supplied to the document handler.

Referring to FIG. 8, the valve body has been shifted to the second operational position by the first solenoid 54. Here, the passageways 142, 144 are connected to the document handler. Accordingly, vacuum is supplied to the vacuum belt.

Based on measurements made of one prior art valve used with document handlers, the time needed to apply a full vacuum at the outlet is about 30 ms. The same valve returns the outlet to atmospheric pressure in 26 ms. The solenoid valve 10 of the present invention is expected to provide a full vacuum within 6 ms and return the outlet to atmospheric in 6 ms. This is an appreciable decrease in operational time by comparison with the prior art.

It is also contemplated that the solenoids 54, 56 may be operated to respond within a predetermined time window, such as 25 ms, 20 ms, 15 ms, 10 ms, or any other time period therebetween. It is contemplated that this adjustment may be required to adapt the solenoid valve 10 to a particular application, such as an existing document handler or the like.

In a variation on this construction, it is contemplated that the non-vacuum gas is at a pressure slightly higher than atmospheric pressure. If a slightly positive pressure is applied, the slightly higher pressure may be applied to the documents to forcibly release the documents from the vacuum belt or other document handler. This may offer advantages in certain document handling circumstances. In the case where the non-vacuum is at a pressure higher than atmospheric pressure, it is contemplated that the vacuum pressure will be below atmospheric so that documents may be picked up by the document handler.

As noted above, the “vacuum” for purposes of the present invention is defined with respect to the “non-vacuum”. Specifically, the vacuum is at a lower pressure than the non-vacuum, which is atmospheric pressure in one contemplated embodiment. The relative magnitudes of these two pressures may be determined by those skilled in the art and are, therefore, not elaborated upon further.

As would be appreciated by those skilled in the art, there are numerous variations on and equivalents to the embodiments described herein that may be employed without departing from the scope of the present disclosure.

We claim:

1. A control valve, comprising:
a housing that defines a first lateral side and a second lateral side;
a valve body disposed within the housing, wherein the valve body defines a first lateral end and a second lateral end;
a first solenoid operably connected to the first lateral end of the valve body;
a second solenoid operably connected to the second lateral end of the valve body;
a first fluid inlet in the housing adapted to receive a first fluid, wherein the first fluid is at a first predetermined pressure;
a second pressure inlet in the housing adapted to receive a second fluid, wherein the second fluid is at a second predetermined pressure;
an outlet defined in the housing;
wherein the valve body is moveable between a first position and a second position;
wherein, in the first position, the valve body is disposed adjacent to the first lateral side of the housing;
wherein, in the second position, the valve body is disposed adjacent to the second lateral side of the housing;
wherein, in the first position, the second fluid is connected to the outlet; and
wherein, in the second position, the first fluid is connected to the outlet.

2. The control valve of claim 1, wherein the first predetermined pressure is less than the second predetermined pressure.

3. The control valve of claim 2, wherein the first fluid and the second fluid are both gases.

4. The control valve of claim 3, wherein the first fluid and the second are both air.

5. The control valve of claim 4, wherein the second predetermined pressure is atmospheric pressure.

6. The control valve of claim 4, wherein the first predetermined pressure is a vacuum.

7. The control valve of claim 1, wherein the first solenoid is disposed on the first lateral side of the housing.

8. The control valve of claim 1, wherein the second solenoid is disposed on the second lateral side of the housing.

9. The control valve of claim 1, wherein:
the valve body comprises a valve stem and plurality of valve members disposed at predetermined positions on the valve stem;
the housing defines a plurality of valve seats; and
the plurality of valve members engage the plurality of valve seats when the valve body is in the first and second positions.

10. The control valve of claim 9, wherein:
the plurality of valve members comprise at least one first valve member and at least one second valve member;
the plurality of valve seats comprise at least one first valve seat and at least one second vale seat;
the at least one first valve member engages the at least one first valve seat when the valve body is in the first position; and
the at least one second valve member engages the at least one second valve seat when the valve body is in the second position.

11. A method of operating a control valve comprising a housing that defines a first lateral side and a second lateral side, a valve body disposed within the housing, wherein the valve body defines a first lateral end and a second lateral end, a first solenoid operably connected to the first lateral end of the valve body, a second solenoid operably connected to the second lateral end of the valve body, a first fluid inlet in the housing adapted to receive a first fluid, wherein the first fluid is at a first predetermined pressure, a second pressure inlet in the housing adapted to receive a second fluid, wherein the second fluid is at a second predetermined pressure, an outlet defined in the housing, the method comprising:
energizing one of the first or second solenoids;
moving the valve body to the first position as a result of energizing the one of the first or second solenoids;
connecting the first fluid to the outlet as a result of moving the valve body to the first position;
energizing the other of the first or second solenoids;
moving the valve body to the second position as a result of energizing the other of the first or second solenoids; and
connecting the second fluid to the outlet as a result of moving the valve body to the second position.

12. The method of claim 11, wherein, in the first position, the valve body is disposed adjacent to the first lateral side of the housing.

13. The method of claim 11, wherein, in the second position, the valve body is disposed adjacent to the second lateral side of the housing.

14. The method of claim 11, wherein the second solenoid is energized to move the valve body to the first position and the first solenoid is energized to move the valve body to the second position.

15. The method of claim 11, wherein, by energizing the other of the first or second solenoids, the first fluid is disconnected from the outlet.

16. The method of claim 14, wherein the first and second solenoids are energized cyclically to repeatedly connect and disconnect the first and second fluids to and from the outlet.

17. The method of claim 16, wherein the first and second fluids are cyclically connected to and from the outlet during a time period of less or equal to about 15 ms.

18. The method of claim 17, wherein the time period of less than or equal to about 10 ms.

19. The method of claim 18, wherein the time period of less than or equal to about 6 ms.

20. The method of claim 11, wherein the first fluid is a vacuum and the second fluid is air at substantially atmospheric pressure.
